(19) United States
(12) Patent Application Publication
(10) Pub. No.: US 2019/0146519 A1
(43) Pub. Date: May 16, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Hiroshi Miura, Wako-shi (JP); Makoto Ishikawa, Wako-shi (JP); Masamitsu Tsuchiya, Wako-shi (JP); Koji Kawabe, Wako-shi (JP)

(21) Appl. No.: 16/177,504

(22) Filed: Nov. 1, 2018

(30) Foreign Application Priority Data
Nov. 16, 2017 (JP) 2017-221277

(51) Int. Cl. G05D 1/02; G06K 9/00; G05D 1/00

(52) U.S. Cl. CPC G05D 1/0246; G06K 9/00798; G06K 9/00805; G05D 2201/0213; G05D 1/0088; G05D 1/0223; G06K 9/00369

(57) ABSTRACT

A vehicle control device (100 or 400) includes a recognizer (130 or 432) that recognizes a surrounding situation of a vehicle, and a driving controller (150 and 160, or 452) that controls at least acceleration and deceleration of the vehicle, the driving controller decelerating the vehicle with different deceleration patterns on the basis of whether a pedestrian crossing the crosswalk has been recognized by the recognizer at a point in time when a marking indicating the presence of the crosswalk in advance has been recognized by the recognizer.

### CROSS-REFERENCE TO RELATED APPLICATION

Priority is claimed on Japanese Patent Application No. 2017-221277, filed Nov. 16, 2017, the content of which is incorporated herein by reference.

### BACKGROUND OF THE INVENTION

### Field of the Invention

The present invention relates to a vehicle control device, a vehicle control method, and a storage medium.

### Description of Related Art

In the related art, an invention of a device that brakes a subject vehicle so that both a collision between the subject vehicle and a crossing person and a collision between the subject vehicle and an oncoming vehicle are avoided when the subject vehicle crosses an opposite lane and turns right or left has been developed (see, for example, Japanese Unexamined Patent Application, First Publication No. 2017-140993).

In a case in which this device detects the presence of a crossing person crossing a crosswalk near an intersection on a road that the subject vehicle tries to enter by turning right when the subject vehicle turns right across an opposite lane at the intersection, detects a size of a space in front of the crosswalk between the crosswalk that the detected crossing person crosses and the opposite lane, and performs control to brake the subject vehicle so that at least collision between the subject vehicle and the crossing person is avoided, the device brakes the subject vehicle on the basis of the detected size of the space in front of the crosswalk (for example, Japanese Unexamined Patent Application, First Publication No. 2017-140993).

### SUMMARY OF THE INVENTION

In the related art, appropriate deceleration cannot be performed on the basis of a situation of the crosswalk in some cases.

Aspects of the present invention have been made in view of such circumstances, and an object thereof is to provide a vehicle control device, a vehicle control method, and a storage medium capable of performing appropriate deceleration on the basis of a situation of a crosswalk.

A vehicle control device, a vehicle control method, and a storage medium according to the present invention adopt the following configurations.

(1): A vehicle control device according to an aspect of the present invention includes a recognizer that recognizes a surrounding situation of a vehicle; and a driving controller that controls at least acceleration and deceleration of the vehicle, the driving controller decelerating the vehicle with different deceleration patterns on the basis of whether a pedestrian crossing the crosswalk has been recognized by the recognizer at a point in time when a marking indicating the presence of the crosswalk in advance has been recognized by the recognizer.

(2): In the aspect of (1), when the pedestrian crossing the crosswalk has not been recognized by the recognizer at a point in time when the marking indicating the presence of the crosswalk drawn on a road has been recognized by the recognizer, the driving controller decelerates the vehicle with a first deceleration pattern including a first period in which the vehicle is decelerated at a first degree of deceleration and a second period in which the vehicle is decelerated at a second degree of deceleration lower than the first degree of deceleration or is caused to travel at a constant speed after the first period.

(3): In the aspect (2), in a case in which the pedestrian crossing the crosswalk has been recognized by the recognizer in the second period when the driving controller decelerates the vehicle with the first deceleration pattern, the driving controller decelerates the vehicle at a third degree of deceleration higher than the second degree of deceleration.

(4): In the aspect (1), the recognizer estimates whether or not a pedestrian recognized near the crosswalk intends to cross, and the driving controller decelerates the vehicle due to the recognizer estimating that the pedestrian intends to cross, and then accelerates the vehicle after the driving controller causes the vehicle to pass through the crosswalk at a predetermined speed or less in a case in which the pedestrian estimated to intend to cross by the recognizer has not started crossing of the crosswalk.

(5): In the aspect (2), in a case in which the pedestrian crossing the crosswalk has been recognized at a point in time when the marking indicating the presence of the crosswalk drawn on a road has been recognized by the recognizer, the driving controller decelerates the vehicle with a second deceleration pattern different from the first deceleration pattern.

(6): In the aspect (5), the second deceleration pattern is a deceleration pattern in which a fluctuation in deceleration is smaller than in the first deceleration pattern.

(7): A vehicle control device according to another aspect of the present invention includes a recognizer that recognizes a surrounding situation of a vehicle; and a driving controller that controls at least acceleration and deceleration of the vehicle, the driving controller decelerating the vehicle with different deceleration patterns on the basis of whether a pedestrian crossing the crosswalk has been recognized by the recognizer at a deceleration start point in front of the crosswalk.

(8): A vehicle control method according to still another aspect of the present invention includes recognizing, by a recognizer, a surrounding situation of a vehicle; controlling, by a driving controller, at least acceleration and deceleration of the vehicle; and decelerating, by the driving controller, the vehicle with different deceleration patterns on the basis of whether a pedestrian crossing the crosswalk has been recognized by the recognizer at a point in time when a marking indicating the presence of the crosswalk in advance has been recognized by the recognizer

(9): A storage medium according to still another aspect of the present invention is a storage medium storing a program for causing a computer to execute: a process of recognizing a surrounding situation of a vehicle; a process of controlling at least acceleration and deceleration of the vehicle; and a process of decelerating the vehicle with different deceleration patterns on the basis of whether a pedestrian crossing a crosswalk has been recognized at a point in time when a marking indicating the presence of the crosswalk in advance has been recognized in the recognizing process.

According to (1) to (9), it is possible to perform appropriate deceleration on the basis of the situation of the crosswalk.

According to (2), it is possible to reduce a speed fluctuation of the vehicle in a period in which a situation of the crosswalk is monitored and to maintain high recognition accuracy by decelerating the vehicle with the first deceleration pattern including the first period in which the vehicle is decelerated at the first degree of deceleration and the second period in which the vehicle is decelerated at the second degree of deceleration lower than the first degree of deceleration or is caused to travel at the constant speed after the first period. It is possible to suppress an unpleasant feeling of occupants of the vehicle due to an unnecessary speed fluctuation. For example, when a peak of the degree of deceleration is reached in front of the crosswalk, the speed fluctuation increases at the time of confirmation of the absence of the crossing pedestrian and performance of acceleration. According to (2), it is possible to reduce a probability of occurrence of such inconvenience.

According to (4), it is possible to cause the vehicle to pass through the crosswalk slowly and smoothly.

According to (5) and (6), when a probability of the vehicle stopping in front of the crosswalk has been revealed to be high in advance, it is possible to adopt a more monotonic deceleration pattern and smoothly stop the vehicle.

### BRIEF DESCRIPTION OF THE DRAWINGS

FIG. 1 is a configuration diagram of a vehicle system 1 using a vehicle control device according to a first embodiment.

FIG. 2 is a functional configuration diagram of a first controller 120 and a second controller 160.

FIG. 3 is a diagram illustrating a landscape near a crosswalk.

FIG. 4 is a diagram illustrating a relationship among a crossing pedestrian Pc, a pre-crossing pedestrian Pp, and a general pedestrian Pn.

FIG. 5 is a diagram illustrating a deceleration pattern when neither the crossing pedestrian Pc nor the pre-crossing pedestrian Pp has been recognized at a point in time when the prior notice marking CM has been recognized by the marking recognizer 134, nor have they been recognized after that point in time.

FIG. 6 is a diagram illustrating a deceleration pattern when neither the crossing pedestrian Pc nor the pre-crossing pedestrian Pp has been recognized at a point in time when the prior notice marking CM has been recognized by the marking recognizer 134, but the crossing pedestrian Pc has been recognized after that point in time.

FIG. 7 is a diagram illustrating a deceleration pattern when neither the crossing pedestrian Pc nor the pre-crossing pedestrian Pp has been recognized at a point in time when the prior notice marking CM has been recognized by the marking recognizer 134, but the pre-crossing pedestrian Pp has been recognized after that point in time.

FIG. 8 is a diagram illustrating a deceleration pattern when the crossing pedestrian Pc has been recognized at a point in time when the prior notice marking CM has been recognized by the marking recognizer 134.

FIG. 9 is a diagram illustrating a deceleration pattern when the pre-crossing pedestrian Pp has been recognized at a point in time when the prior notice marking CM has been recognized by the marking recognizer 134.

FIG. 10 is a flowchart (part 1) illustrating an example of a flow of a process that is executed by a deceleration controller 152.

FIG. 11 is a flowchart (part 2) illustrating an example of a flow of a process that is executed by a deceleration controller 152.

FIG. 12 is a flowchart (part 3) illustrating an example of a flow of a process that is executed by a deceleration controller 152.

FIG. 13 is a configuration diagram of an automated stop assistance device 400 according to a second embodiment.

FIG. 14 is a diagram illustrating an example of a hardware configuration of the automated driving controller 100 of the first embodiment or the automated stop assistance device 400 of the second embodiment.

### DESCRIPTION OF EMBODIMENTS

Hereinafter, embodiments of a vehicle control device, a vehicle control method, and a program of the present invention will be described with reference to the drawings.

### First Embodiment

[Overall Configuration]

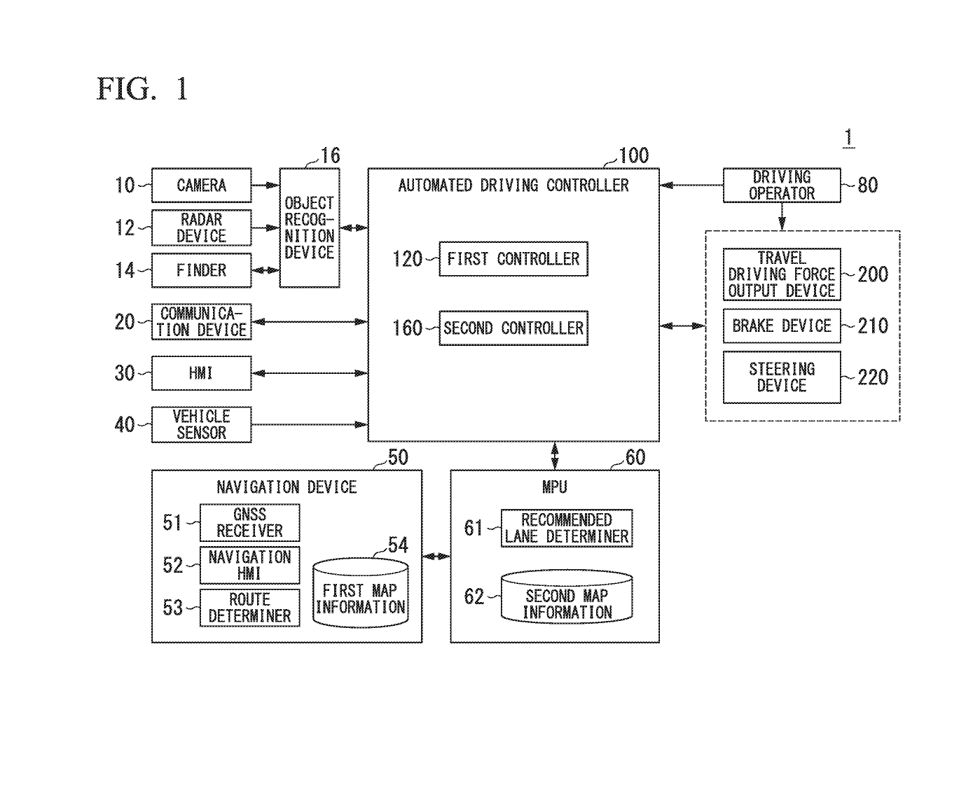

FIG. 1 is a configuration diagram of a vehicle system 1 using a vehicle control device according to a first embodiment. A vehicle in which the vehicle system 1 is mounted is, for example, a vehicle such as a two-wheeled, three-wheeled, or four-wheeled vehicle. A driving source thereof is an internal combustion engine such as a diesel engine or a gasoline engine, an electric motor, or a combination thereof. When the electric motor is used, the electric motor is operated using power generated by a generator connected to an internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving controller 100, a travel driving force output device 200, a brake device 210, a steering device 220, and a headlight device 250. The devices or units are connected to each other by a multiplex communication line such as a controller area network (CAN) communication line, a serial communication line, a wireless communication network, or the like. The configuration illustrated in FIG. 1 is merely an example, and a part of the configuration may be omitted, or other configurations may be added.

The camera 10 is, for example, a digital camera using a solid-state imaging element such as a charge coupled device (CCD) or a complementary metal oxide semiconductor (CMOS). One or a plurality of cameras 10 are attached to any places on a vehicle in which the vehicle system 1 is mounted (hereinafter referred to as a subject vehicle M). In the case of forward imaging, the camera 10 is attached to an upper portion of a front windshield, a rear surface of a rearview mirror, or the like. The camera 10, for example, periodically repeatedly images the surroundings of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (distance and orientation) of the object. One or a plurality of radar devices 12 are attached to any places on the subject vehicle M. The radar device 12 may detect a position and a speed of an object using a frequency modulated continuous wave (FM-CW) scheme.

The finder 14 is a light detection and ranging (LIDAR). The finder 14 radiates light around the subject vehicle M and measures scattered light. The finder 14 detects a distance to a target on the basis of a time from light emission to light reception. The radiated light is, for example, pulsed laser light. One or a plurality of finders 14 are attached to any places on the subject vehicle M. The finder 14 is an example of an object detection device.

The object recognition device 16 performs a sensor fusion process on detection results of some or all of the camera 10, the radar device 12, and the finder 14 to recognize a position, type, speed, and the like of an object. The object recognition device 16 outputs recognition results to the automated driving controller 100. The object recognition device 16 may output the detection results of the camera 10, the radar device 12, or the finder 14 to the automated driving controller 100 as they are according to necessity.

The communication device 20, for example, communicates with another vehicle near the subject vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the subject vehicle M and receives an input operation from the occupant. The HMI 30 includes various display devices, speakers, buzzers, a touch panel, switches, keys, and the like.

The vehicle sensor 40 includes, for example, a vehicle speed sensor that detects a speed of the subject vehicle M, an acceleration sensor that detects an acceleration, a yaw rate sensor that detects an angular speed around a vertical axis, and an orientation sensor that detects a direction of the subject vehicle M.

The navigation device 50 includes, for example, a global navigation satellite system (GNSS) receiver 51, a navigation HMI 52, and a route determiner 53, and holds first map information 54 in a storage device such as a hard disk drive (HDD) or a flash memory. The GNSS receiver 51 specifies a position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determiner 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route determined by the route determiner 53 is output to the MPU 60. The navigation device 50 may perform route guidance using the navigation HMI 52 on the basis of the on-map route determined by the route determiner 53. The navigation device 50 may be realized, for example, by a function of a terminal device such as a smartphone or a tablet terminal possessed by the occupant. The navigation device 50 may transmit a current position and a destination to a navigation server via the communication device 20 and acquire the on-map route with which the navigation server replies.

The MPU 60, for example, functions as a recommended lane determiner 61, and holds second map information 62 in a storage device such as an HDD or a flash memory. The recommended lane determiner 61 divides the route provided from the navigation device 50 into a plurality of blocks (for example, divides the route every 100 [m] in a progression direction of the vehicle), and determines a recommended lane for each block by referring to the second map information 62. The recommended lane determiner 61 determines in which lane from the left the subject vehicle M travels. The recommended lane determiner 61 determines the recommended lane so that the subject vehicle M can travel on a reasonable route for progression to a branch destination when there is a branch point, a merging point, or the like in the route.

The second map information 62 is map information with higher accuracy than the first map information 54. The second map information 62 includes, for example, information on a center of the lane or information on a boundary of the lane. The second map information 62 may include road information, traffic regulation information, address information (address and postal code), facility information, telephone number information, and the like. The second map information 62 may be updated at any time by accessing another device using the communication device 20.

The driving operator 80 includes, for example, an accelerator pedal, a brake pedal, a shift lever, a steering wheel, a modified steering wheel, a joystick, and other operators. A sensor that detects the amount of operation or the presence or absence of the operation is attached to the driving operator 80, and a result of the detection is output to some or all of the automated driving controller 100, the travel driving force output device 200, the brake device 210, and the steering device 220.

The automated driving controller 100 includes, for example, a first controller 120, and a second controller 160. Each of the first controller 120 and the second controller 160 is realized, for example, by a hardware processor such as a central processing unit (CPU) executing a program (software). Some or all of such components may be realized by hardware (including circuitry) such as a large scale integration (LSI), an application specific integrated circuit (ASIC), a field-programmable gate array (FPGA), or a graphics processing unit (GPU) or may be realized by software and hardware in cooperation. The automated driving controller 100 is an example of a vehicle control device.

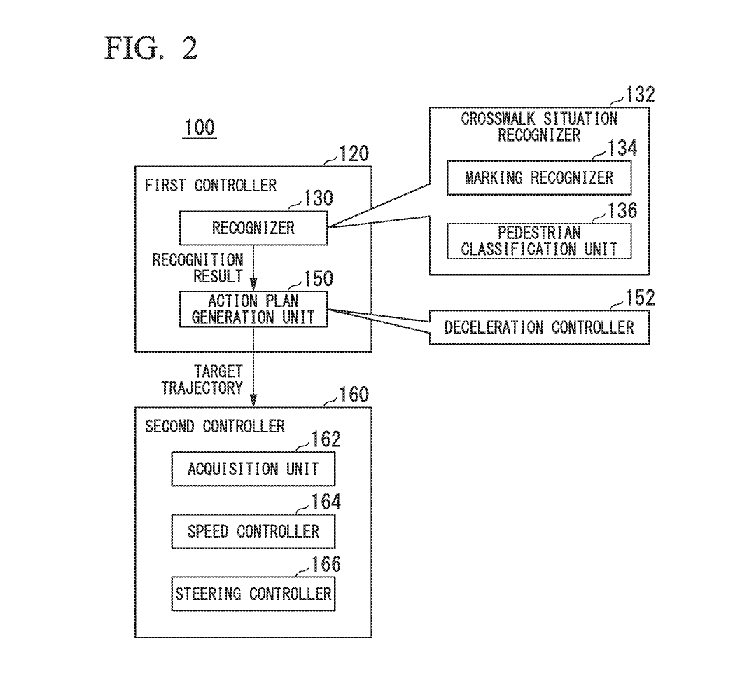

FIG. 2 is a functional configuration diagram of the first controller 120 and the second controller 160. The first controller 120 includes, for example, a recognizer 130 and an action plan generation unit 150. The first controller 120 realizes, for example, a function based on artificial intelligence (AI) and a function based on a previously given model in parallel. For example, in a function of “recognizing crossing,” recognition of crossing using deep learning or the like and recognition based on previously given conditions (a signal which can be subjected to pattern matching, a road sign, or the like) are executed in parallel, and the function is realized by scoring both recognitions and comprehensively evaluating the recognitions. Accordingly, the reliability of automated driving is guaranteed.

The recognizer 130 recognizes a surrounding situation of the subject vehicle M on the basis of information input from the camera 10, the radar device 12, and the finder 14 via the object recognition device 16. For example, the recognizer 130 recognizes a position and a state such as a speed or an acceleration of an object near the subject vehicle M. The position of the object is recognized, for example, as a position based on absolute coordinates with a representative point (for example, a centroid or a driving axis center) of the subject vehicle M as an origin, and is used for control. The position of the object may be represented by a representative point such as a centroid or a corner of the object or may be represented by an indicated area. The “state” of the object may include an acceleration or jerk of the object, or an “action state” (for example, whether or not the object is changing lanes or is about to change lanes). The recognizer 130 recognizes a shape of a curve that the subject vehicle M is about to pass on the basis of a captured image of the camera 10. The recognizer 130 converts the shape of the curve from the captured image of the camera 10 to a real plane and outputs, for example, two-dimensional point sequence information or information represented by using a model equivalent thereto to the action plan generation unit 150 as information indicating the shape of the curve.

The recognizer 130 recognizes, for example, a lane (traveling lane) in which the subject vehicle M is traveling. For example, the recognizer 130 compares a pattern of a road marking line (for example, an arrangement of a solid line and a broken line) obtained from the second map information 62 with a pattern of a road marking line near the subject vehicle M recognized from the image captured by the camera 10 to recognize the traveling lane. It should be noted that the recognizer 130 may recognize not only the road marking line but also a traveling road boundary (road boundary) including the road marking line, a road shoulder, a curb, a median strip, a guard rail, or the like to recognize the traveling lane. In this recognition, the position of the subject vehicle M acquired from the navigation device 50 or a processing result of an INS may be added. The recognizer 130 recognizes a temporary stop line, an obstacle, a red light, a toll gate, and other road events.

The recognizer 130 recognizes a position or a posture of the subject vehicle M relative to the traveling lane when recognizing the traveling lane. The recognizer 130 may recognize, for example, a deviation of a reference point of the subject vehicle M from a center of the lane, and an angle formed with respect to a line connecting a center of a lane in a progression direction of the subject vehicle M as a relative position and a posture of the subject vehicle M with respect to the traveling lane. Instead, the recognizer 130 may recognize, for example, a position of the reference point of the subject vehicle M with respect to any one of side end portions (the road marking line or the road boundary) of the traveling lane as the relative position of the subject vehicle M with respect to the traveling lane.

The recognizer 130 may derive recognition accuracy in the above recognition process and output the recognition accuracy as recognition accuracy information to the action plan generation unit 150. For example, the recognizer 130 generates the recognition accuracy information on the basis of a frequency of recognition of the road marking lines in a certain period.

The recognizer 130 includes, for example, a crosswalk situation recognizer 132. The crosswalk situation recognizer 132 includes, for example, a marking recognizer 134 and a pedestrian classification unit 136. These will be described below.

In principle, the action plan generation unit 150 determines events to be sequentially executed in automated driving so that the subject vehicle M can travel on the recommended lane determined by the recommended lane determiner 61 and cope with the surrounding situation of the subject vehicle M. The action plan generation unit 150 generates a target trajectory along which the subject vehicle M will travel in the future according to an activated event. The target trajectory includes, for example, a plurality of trajectory points and a speed element. For example, the target trajectory is represented as a sequence of points (trajectory points) to be reached by the subject vehicle M. The trajectory point is a point that the subject vehicle M is to reach for each predetermined travel distance (for example, several meters) at a road distance, and a target speed and a target acceleration at every predetermined sampling time (for example, several tenths of a [sec]) are separately generated as part of the target trajectory. The trajectory point may be a position that the subject vehicle M is to reach at the sampling time at every predetermined sampling time. In this case, information on the target speed or the target acceleration is represented by the interval between the trajectory points.

The action plan generation unit 150 includes, for example, a deceleration controller 152. This will be described below.

The second controller 160 controls the travel driving force output device 200, the brake device 210, and the steering device 220 so that the subject vehicle M passes through the target trajectory generated by the action plan generation unit 150 at a scheduled time. A combination of the action plan generation unit 150 and the second controller 160 is an example of a “driving controller.”

The second controller 160 includes, for example, an acquisition unit 162, a speed controller 164, and a steering controller 166. The acquisition unit 162 acquires information on the target trajectory (track points) generated by the action plan generation unit 150 and stores the information on the target trajectory in a memory (not illustrated). The speed controller 164 controls the travel driving force output device 200 or the brake device 210 on the basis of the speed element incidental to the target trajectory stored in the memory. The steering controller 166 controls the steering device 220 according to a degree of bend of the target trajectory stored in the memory. Processes of the speed controller 164 and the steering controller 166 are realized by, for example, a combination of feedforward control and feedback control. For example, the steering controller 166 executes a combination of feedforward control according to a curvature of a road in front of the subject vehicle M and feedback control based on a deviation from the target trajectory.

The travel driving force output device 200 outputs a travel driving force (torque) for traveling of the subject vehicle M to the driving wheels. The travel driving force output device 200 includes, for example, a combination with an internal combustion engine, an electric motor, a transmission, and the like, and an ECU that controls these. The ECU controls the above configuration according to information input from the second controller 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second controller 160 or information input from the driving operator 80 so that a brake torque corresponding to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the second controller 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second controller 160 or information input from the driving operator 80 to change the direction of the steerable wheels.

[Deceleration Control Before Crosswalk]

Hereinafter, content of a process that is executed by the crosswalk situation recognizer 132 of the recognizer 130 and the deceleration controller 152 of the action plan generation unit 150 will be described.

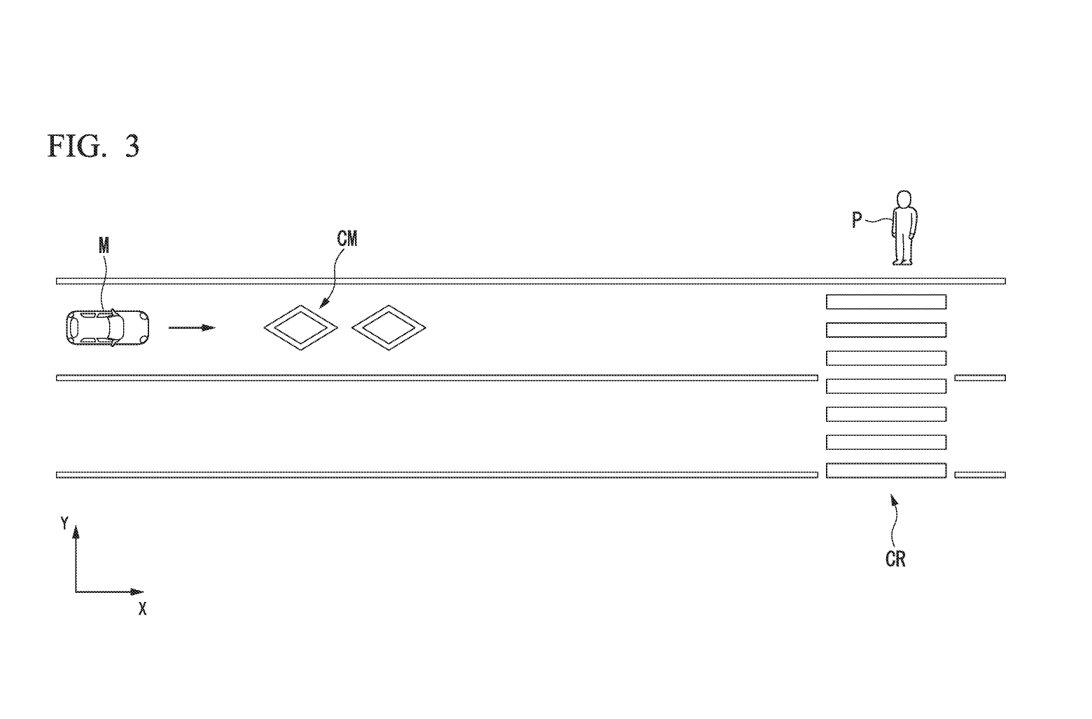

The marking recognizer 134 of the crosswalk situation recognizer 132 recognizes a marking (hereinafter referred to as a prior notice indication) indicating the presence of the crosswalk in advance. FIG. 3 is a diagram illustrating a landscape near the crosswalk. In some cases, a prior notice marking CM is drawn on a road in front of a crosswalk CR (at a position at which a vehicle will reach a crosswalk when the vehicle progresses as it is). The marking recognizer 134 recognizes a position of the prior notice marking CM relative to the subject vehicle M on the basis of, for example, the captured image of the camera 10. For example, a scheme such as a pattern matching is used for recognition of a position of the prior notice marking CM. The marking recognizer 134 may also be able to cope with a case in which an indication in another aspect is drawn as the prior notice marking CM.

The pedestrian classification unit 136 of the crosswalk situation recognizer 132 starts a process at a point in time when the prior notice marking CM has been recognized, for example, by the marking recognizer 134 (may start the process before the point in time). The crosswalk situation recognizer 132 recognizes a position of the crosswalk CR and a pedestrian P near the crosswalk CR and classifies the pedestrian P. For example, the pedestrian classification unit 136 classifies the pedestrian P into any one of a crossing pedestrian Pc crossing the crosswalk CR, a pre-crossing pedestrian Pp that does not correspond to the crossing pedestrian Pc but is estimated to intend crossing, and a general pedestrian Pn that is neither a crossing pedestrian Pc or a pre-crossing pedestrian Pp.

The pedestrian classification unit 136 recognizes the position of the crosswalk CR on the basis of, for example, the image captured by the camera 10 or compares the position of the subject vehicle M measured by the navigation device 50 with the second map information 62 and recognizes the position of the crosswalk CR. The pedestrian classification unit 136 recognizes the pedestrian P using a machine learning scheme such as deep learning or a scheme such as pattern matching.

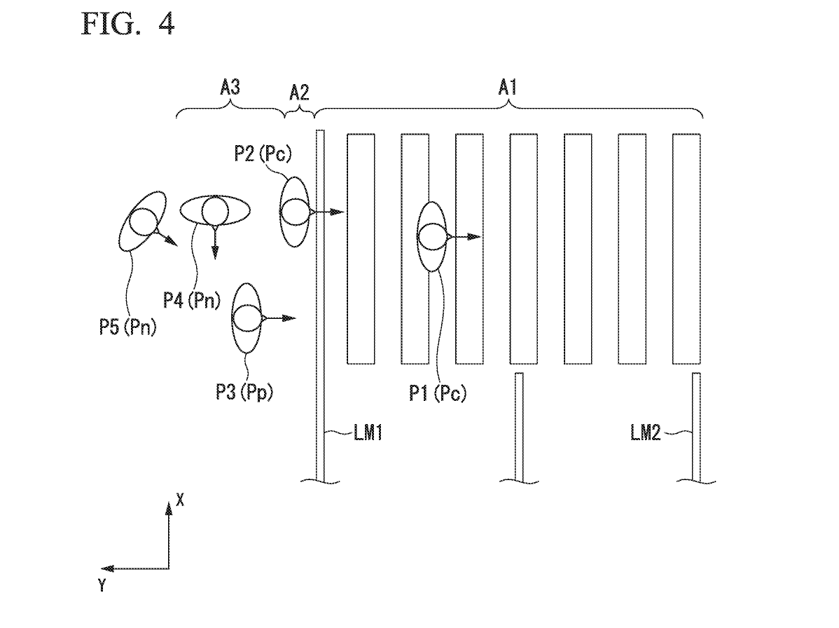

FIG. 4 is a diagram illustrating a relationship among the crossing pedestrian Pc, the pre-crossing pedestrian Pp, and the general pedestrian Pn. In FIG. 4, five pedestrians P1 to P5 are illustrated. In FIG. 4, arrows indicate velocity vectors of the respective pedestrians P.

(1) The pedestrian classification unit 136 classifies the pedestrian P within a crosswalk area A1 into the crossing pedestrian Pc irrespective of the velocity vector. The crosswalk area A1 is, for example, an area that is partitioned by outer end portions of road marking lines at both ends (outer end portions on the endmost side of the crosswalk when the crosswalk is drawn) in a road width direction (a Y direction in FIG. 4). Extension of the area in a progression direction (an X direction in FIG. 4) may be arbitrarily set or may be set to include at least an area in which the crosswalk is drawn. The extension of the area in the progression direction (the X direction in FIG. 4) applies to other areas A2 and A3. In the example of FIG. 4, the pedestrian classification unit 136 classifies the pedestrian P1 into the crossing pedestrian Pc according to such a rule.

(2) The pedestrian classification unit 136 classifies a pedestrian P present in the extended area A2 outside the crosswalk area A1 (only the left side is illustrated in FIG. 4) into the pre-crossing pedestrian Pp when a component in the road width direction of the velocity vector (a component in the Y direction in FIG. 4) is equal to or greater than a threshold value Th1. In the velocity vector, a direction toward a center of the road is positive. In the example of FIG. 4, the pedestrian classification unit 136 recognizes that a pedestrian P2 is the crossing pedestrian Pc according to such a rule.

(3) The pedestrian classification unit 136 classifies, for example, a pedestrian P present in a reserved area A3 on the outer side of the extended area A2 into a pre-crossing pedestrian Pp (estimates that the pedestrian P intends to cross) when the component in the road width direction of the velocity vector (the component in the Y direction in FIG. 4) is equal to or greater than a threshold value Th2. In the example of FIG. 4, the pedestrian classification unit 136 classifies a pedestrian P3 into the pre-crossing pedestrian Pp according to such a rule.

(4) The pedestrian classification unit 136 classifies pedestrians P4 and P5 in FIG. 4 into a general pedestrian Pn since the pedestrians P4 and P5 do not correspond to either the crossing pedestrian Pc or the pre-crossing pedestrian Pp. The rules (1) to (4) are only examples. These rules may be arbitrarily changed in a range in which the purpose of a classification process does not change.

The deceleration controller 152 decelerates the subject vehicle M with different deceleration patterns according to a classification result of the pedestrian classification unit 136 at a point in time when the prior notice marking CM has been recognized by the marking recognizer 134.

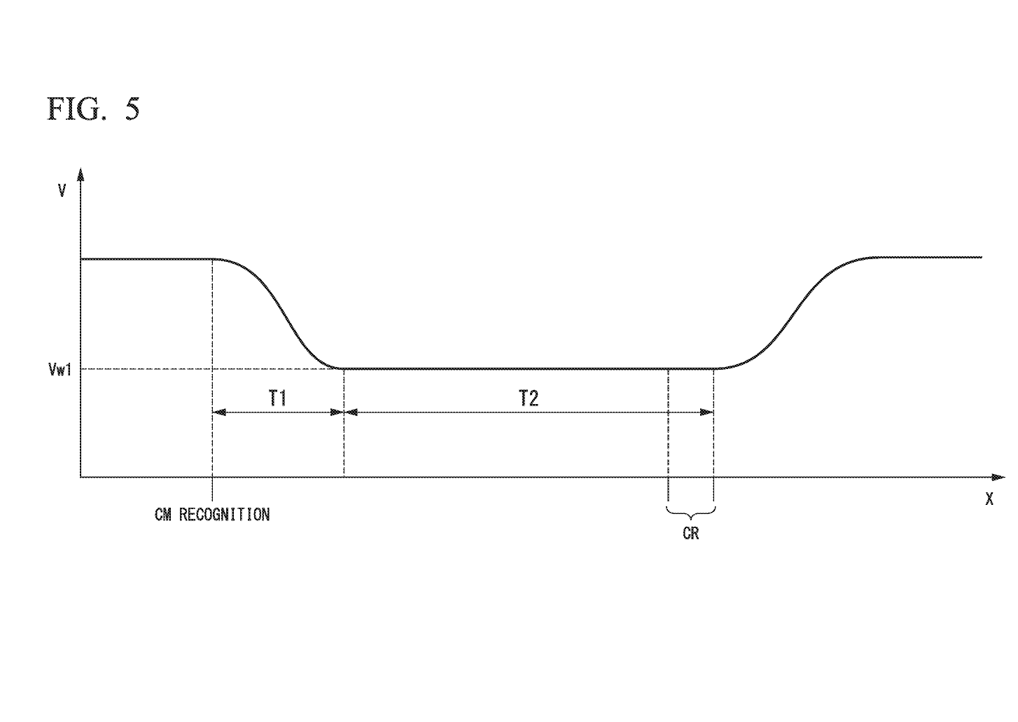

FIG. 5 is a diagram illustrating a deceleration pattern when neither the crossing pedestrian Pc nor the pre-crossing pedestrian Pp has been recognized at a point in time when the prior notice marking CM has been recognized by the marking recognizer 134, and has not also been recognized after the point in time. In FIG. 5, a horizontal axis represents a displacement (X) in a progression direction and a vertical axis represents a speed (V). In this case, the deceleration controller 152 decelerates the subject vehicle M up to a first monitoring speed Vw1 in a period T1 (a first degree of deceleration), and causes the subject vehicle M to maintain the first monitoring speed Vw1 in a period T2 (causes the subject vehicle M to travel at a constant speed) or decelerates the subject vehicle M at a gentle degree of deceleration than in the period T1 (a second degree of deceleration). Thereafter, the deceleration controller 152 accelerates the subject vehicle M at a point in time when the subject vehicle M has passed through the crosswalk CR, and ends the process when the subject vehicle M returns to an original speed. Length of the respective periods illustrated in FIGS. 5 to 9 may be dynamically set according to, for example, a distance from the prior notice marking CM to the crosswalk CR.

By adopting the deceleration pattern illustrated in FIG. 5, it is possible to reduce a speed fluctuation of the vehicle in the period T2 in which a situation of the crosswalk CR is monitored, and to maintain high recognition accuracy. It is possible to suppress an unpleasant feeling of occupants of the subject vehicle M due to an unnecessary speed fluctuation. For example, when a peak of the degree of deceleration is reached in front of the crosswalk CR, the speed fluctuation increases at the time of confirmation of the absence of the crossing pedestrian Pc and performance of acceleration. By adopting the deceleration pattern illustrated in FIG. 5, it is possible to reduce a probability of occurrence of such inconvenience.

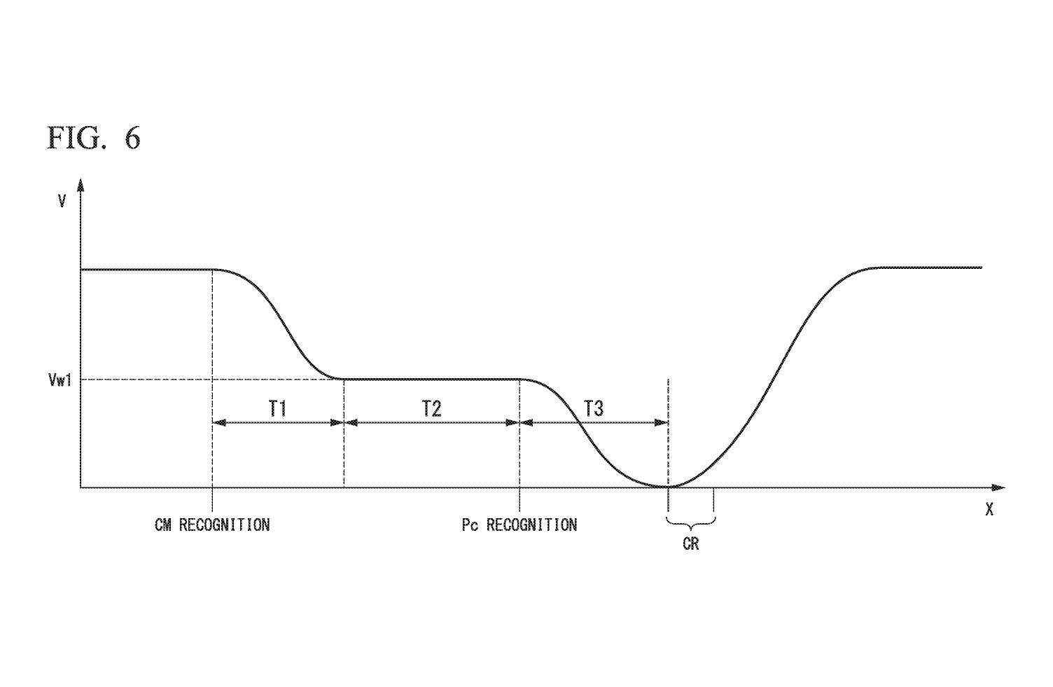

FIG. 6 is a diagram illustrating a deceleration pattern when neither the crossing pedestrian Pc nor the pre-crossing pedestrian Pp has been recognized at a point in time when the prior notice marking CM has been recognized by the marking recognizer 134, but the crossing pedestrian Pc has been recognized in a period T2 after the point in time. In this case, the deceleration controller 152 decelerates the subject vehicle M up to a first monitoring speed Vw1 in a period T1 (a first degree of deceleration), and causes the subject vehicle M to maintain the first monitoring speed Vw1 in a period T2 (causes the subject vehicle M to travel at a constant speed) or decelerates the subject vehicle M at a gentle degree of deceleration than in the period T1 (a second degree of deceleration). Thereafter, the deceleration controller 152 decelerates the subject vehicle M at a third degree of deceleration higher than the degree of deceleration in the period T2 to stop the subject vehicle M in front of the crosswalk. When the crossing pedestrian Pc completes crossing, the deceleration controller 152 starts up and accelerates the subject vehicle M, and ends the process when the subject vehicle M returns to an original speed. When the crossing pedestrian Pc has completed the crossing during the deceleration, the deceleration controller 152 switches to constant speed traveling, and accelerates the subject vehicle M at a point in time when the subject vehicle M has passed through the crosswalk CR.

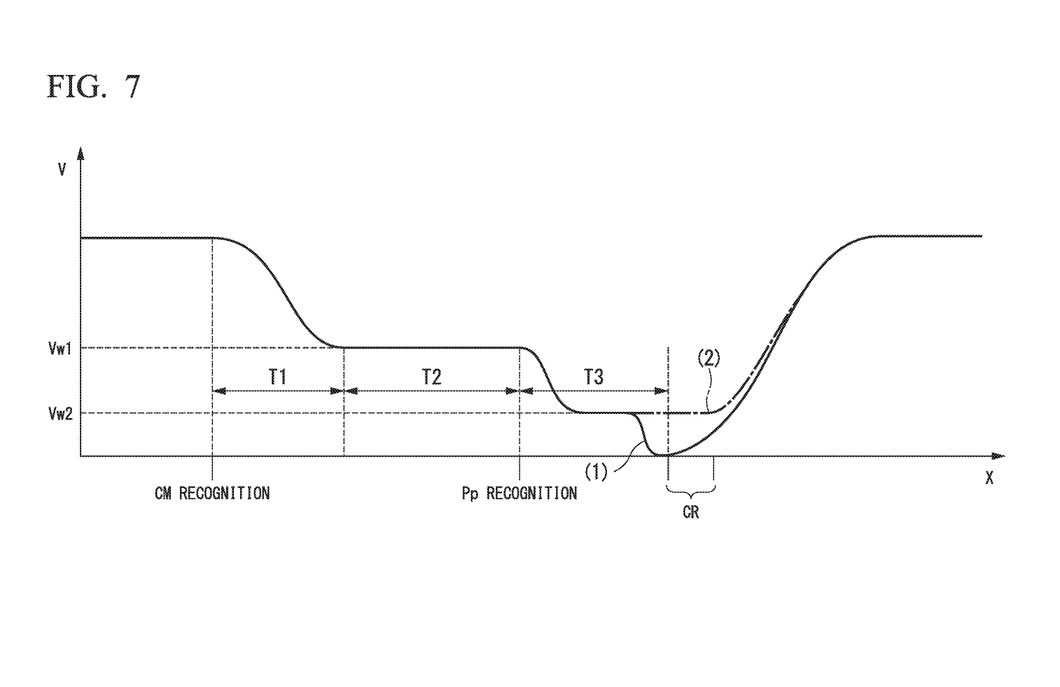

FIG. 7 is a diagram illustrating a deceleration pattern when neither the crossing pedestrian Pc nor the pre-crossing pedestrian Pp has been recognized at a point in time when the prior notice marking CM has been recognized by the marking recognizer 134, but the crossing pedestrian Pc has been recognized in a period T2 after the point in time. In this case, the deceleration controller 152 decelerates the subject vehicle M up to a first monitoring speed Vw1 in a period T1 (a first degree of deceleration), and causes the subject vehicle M to maintain the first monitoring speed Vw1 in a period T2 (causes the subject vehicle M to travel at a constant speed) or decelerates the subject vehicle M at a gentle degree of deceleration than in the period T1 (a second degree of deceleration). Thereafter, the deceleration controller 152 decelerates the subject vehicle M up to a second monitoring speed Vw2 at a third degree of deceleration (which may be different from the third degree of deceleration in the example of FIG. 6) higher than in the period T2 and causes the subject vehicle M to maintain the second monitoring speed Vw2 (causes the subject vehicle M to travel at a constant speed).

When the pedestrian who has been the pre-crossing pedestrian Pp is classified into the crossing pedestrian Pc by the pedestrian classification unit 136, that is, the pedestrian estimated to intend crossing has started crossing while the second monitoring speed Vw2 is maintained, the deceleration controller 152 stops the subject vehicle M in front of the crosswalk. When the crossing pedestrian Pc completes crossing, the deceleration controller 152 starts up and accelerates the subject vehicle M, and ends the process when the subject vehicle M returns to an original speed ((1) indicated by a solid line in FIG. 7).

On the other hand, when the pedestrian who has been a pre-crossing pedestrian Pp has not been classified into the crossing pedestrian Pc by the pedestrian classification unit 136, that is, when the pedestrian estimated to intend crossing has not started crossing while the second monitoring speed Vw2 is being maintained, the deceleration controller 152 causes the subject vehicle M to pass through the crosswalk while maintaining the second monitoring speed Vw2, which is equal to or lower than a predetermined speed, and then, accelerates the subject vehicle M (see (2) indicated by a one-dot chain line in FIG. 7). The deceleration patterns illustrated in FIGS. 5 to 7 are examples of the first deceleration pattern.

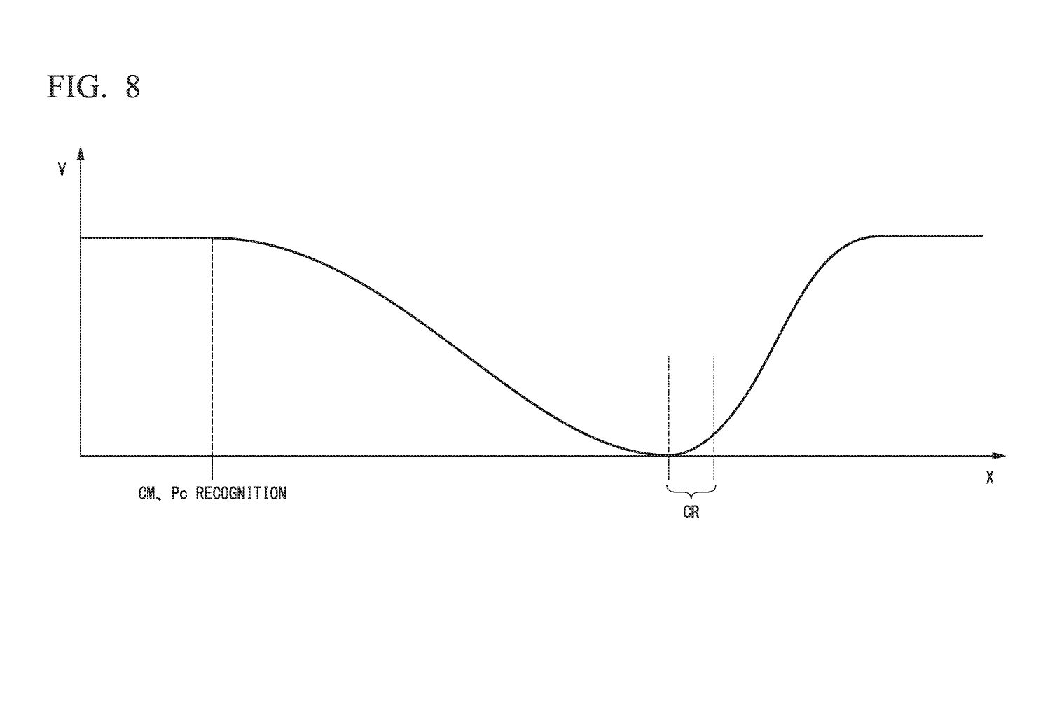

FIG. 8 is a diagram illustrating a deceleration pattern when the crossing pedestrian Pc has been recognized at a point in time when the prior notice marking CM has been recognized by the marking recognizer 134. In this case, the deceleration controller 152 decreases the speed of the subject vehicle M as the subject vehicle M approaches the crosswalk CR with a deceleration pattern in which a fluctuation in deceleration is smaller than those in the deceleration patterns illustrated in FIGS. 5 to 7, to stop the subject vehicle M in front of the crosswalk. When the crossing pedestrian Pc completes crossing, the deceleration controller 152 starts up and accelerates the subject vehicle M, and ends the process when the subject vehicle M returns to an original speed. When the crossing pedestrian Pc has completed the crossing during the deceleration, the deceleration controller 152 switches to constant speed traveling, and accelerates the subject vehicle M at a point in time when the subject vehicle M has passed through the crosswalk CR. The deceleration pattern illustrated in FIG. 8 is an example of a second deceleration pattern. By adopting the deceleration pattern illustrated in FIG. 8, when a probability of the subject vehicle M stopping in front of the crosswalk has been revealed to be high in advance, it is possible to adopt a more monotonic deceleration pattern and smoothly stop the vehicle.

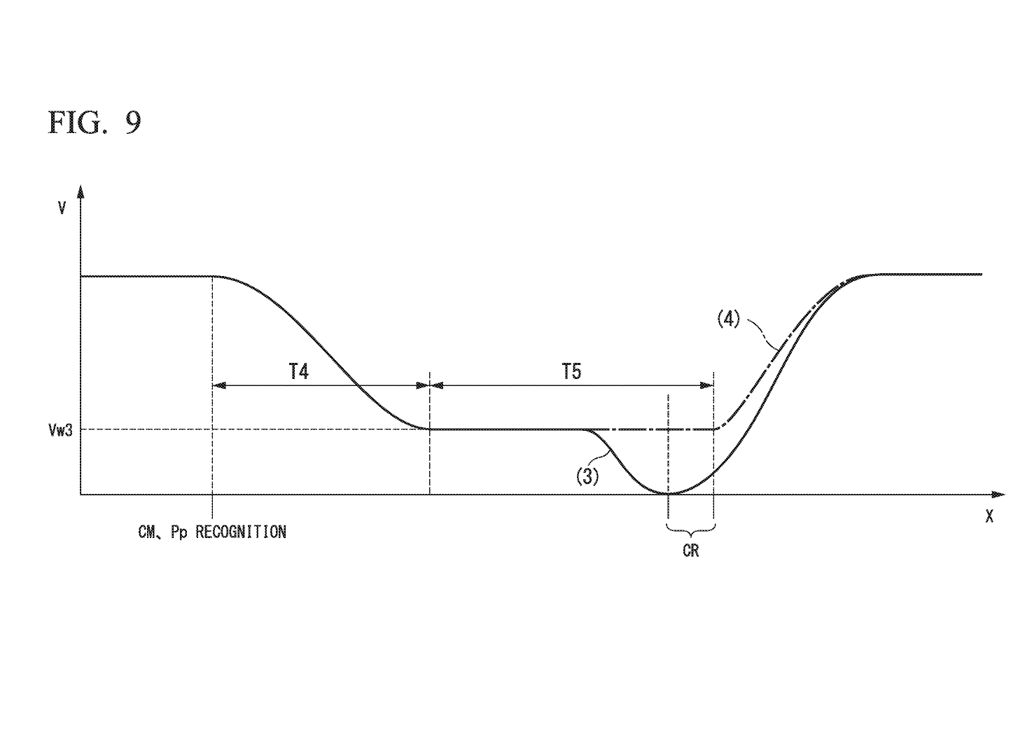

FIG. 9 is a diagram illustrating a deceleration pattern when the pre-crossing pedestrian Pp has been recognized at a point in time when the prior notice marking CM has been recognized by the marking recognizer 134. In this case, the deceleration controller 152 decelerates the subject vehicle up to a third monitoring speed Vw3 in a period T4 and causes the subject vehicle M to maintain the third monitoring speed Vw3 (causes the subject vehicle M to travel at a constant speed) in a period T5 or decelerates the subject vehicle M at a gentle degree of deceleration than in the period T4. Thereafter, when the pedestrian who has been the pre-crossing pedestrian Pp is classified into the crossing pedestrian Pc by the pedestrian classification unit 136, that is, the pedestrian estimated to intend crossing has started crossing, the deceleration controller 152 stops the subject vehicle M in front of the crosswalk. When the crossing pedestrian Pc completes crossing, the deceleration controller 152 starts up and accelerates the subject vehicle M, and ends the process when the subject vehicle M returns to an original speed ((3) indicated by a solid line in FIG. 9). On the other hand, when the pedestrian who has been a pre-crossing pedestrian Pp has not been classified into the crossing pedestrian Pc by the pedestrian classification unit 136, that is, when the pedestrian estimated to intend crossing has not started crossing while the third monitoring speed Vw3 is being maintained, the deceleration controller 152 causes the subject vehicle M to pass through the crosswalk while maintaining the third monitoring speed Vw3, which is equal to or lower than a predetermined speed, and then, accelerates the subject vehicle M (see (4) indicated by a one-dot chain line in FIG. 9). The second monitoring speed Vw2 and the third monitoring speed Vw3 may be the same speed or may be different speeds. For example, Vw2≤Vw3.

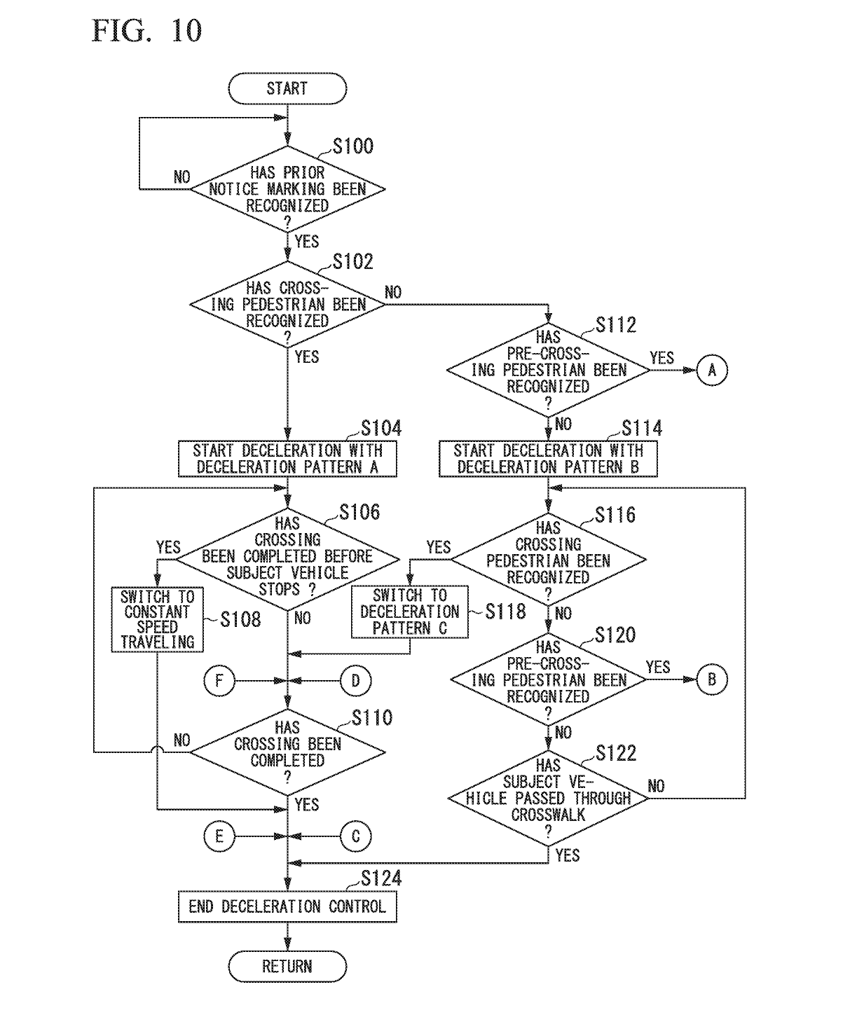

FIGS. 10 to 12 are flowcharts illustrating an example of a flow of a process that is executed by the deceleration controller 152. First, the deceleration controller 152 determines whether or not the prior notice marking CM has been recognized by the marking recognizer 134 (step S100). When the prior notice marking CM is recognized by the marking recognizer 134, the deceleration controller 152 determines whether or not the crossing pedestrian Pc has been recognized by the crosswalk situation recognizer 132 (specifically, whether or not any pedestrian P has been classified as the crossing pedestrian Pc by the pedestrian classification unit 136; the same applies hereinafter) (step S102).

When the crossing pedestrian Pc is recognized by the crosswalk situation recognizer 132, the deceleration controller 152 starts deceleration of the subject vehicle M with a deceleration pattern A (step S104). The deceleration pattern A is the deceleration pattern illustrated in FIG. 8.

Then, the deceleration controller 152 determines whether or not the crossing pedestrian Pc recognized by the crosswalk situation recognizer 132 (all crossing pedestrians Pc when there are a plurality of crossing pedestrians Pc) has completed crossing of the crosswalk CR before the subject vehicle M stops (step S106). When the deceleration controller 152 has determined that the crossing pedestrian Pc has completed the crossing of the crosswalk CR before the subject vehicle M stops, the deceleration controller 152 switches to constant speed traveling (step S108) and accelerates the subject vehicle M to an original speed to end the deceleration control (step S124).

When the deceleration controller 152 has determined in step 5106 that the crossing pedestrian Pc has not completed the crossing of the crosswalk CR before the subject vehicle M stops, the deceleration controller 152 determines whether or not the crossing pedestrian P has completed the crossing (step S110). When the deceleration controller 152 has determined that the crossing pedestrian P has not completed the crossing, the deceleration controller 152 returns to the process of step 5106. On the other hand, when the deceleration controller 152 has determined that the crossing pedestrian P has completed the crossing, the deceleration controller 152 starts up the subject vehicle M and accelerates the subject vehicle M up to the original speed to end the deceleration control (step S124).

When the deceleration controller 152 has determined whether or not the crossing pedestrian Pc has not been recognized by the crosswalk situation recognizer 132 in step 5102, the deceleration controller 152 determines whether or not the pre-crossing pedestrian Pp has been recognized by the crosswalk situation recognizer 132 (step S112). A case in which it is determined that the pre-crossing pedestrian Pp has been recognized by the crosswalk situation recognizer 132 will be described below.

When the deceleration controller 152 has determined that the pre-crossing pedestrian Pp has not been recognized by the crosswalk situation recognizer 132, the deceleration controller 152 starts deceleration of the subject vehicle M with a deceleration pattern B (step S114). The deceleration pattern B is the deceleration pattern illustrated in FIG. 5.

Then, the deceleration controller 152 determines whether or not the crossing pedestrian Pc has been recognized by the crosswalk situation recognizer 132 (step S116). When the deceleration controller 152 has determined that the crossing pedestrian Pc has been recognized by the crosswalk situation recognizer 132, the deceleration controller 152 switches the deceleration pattern to a deceleration pattern C to decelerate the subject vehicle M (step S118), and proceeds to a process of step 5110. The deceleration pattern C is the deceleration pattern illustrated in FIG. 6.

When a negative determination is obtained in step S116, the deceleration controller 152 determines whether or not the pre-crossing pedestrian Pp has been recognized by the crosswalk situation recognizer 132 (step S120). A case in which it is determined that the pre-crossing pedestrian Pp has been recognized by the crosswalk situation recognizer 132 will be described below.

When a negative determination is obtained in step S120, the deceleration controller 152 determines whether or not the subject vehicle M has passed through the crosswalk CR (step S122). When the deceleration controller 152 has determined that the subject vehicle M has not passed through the crosswalk CR, the deceleration controller 152 returns to the process of step S116. On the other hand, when the deceleration controller 152 has determined that the subject vehicle M has passed through the crosswalk CR, the deceleration controller 152 accelerates the subject vehicle M up to the original speed to end the deceleration control (step S124).

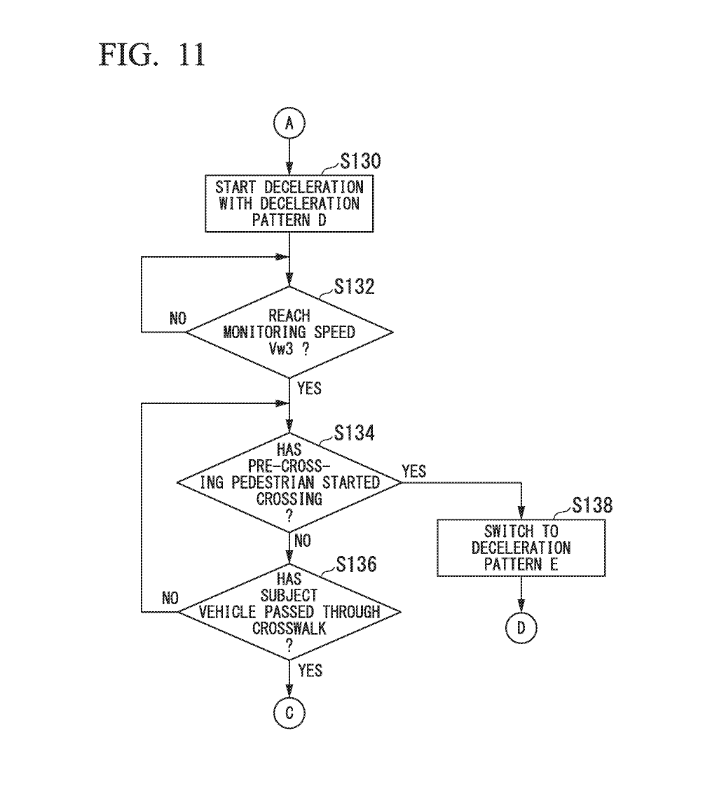

When a positive determination is obtained in step S112, the process proceeds to a process illustrated in FIG. 11. The deceleration controller 152 starts deceleration of the subject vehicle M with a deceleration pattern D (step S130). The deceleration pattern D is a deceleration pattern continuing from (4) indicated by a one-dot chain line in the deceleration pattern illustrated in FIG. 9. Then, the deceleration controller 152 determines whether or not a speed of the subject vehicle M has decreased to reach the monitoring speed Vw3 (step S132).

When the speed of the subject vehicle M decreases to reach the monitoring speed Vw3, the deceleration controller 152 determines whether or not the pedestrian P who has been the pre-crossing pedestrian Pp has been classified into the crossing pedestrian Pc, that is, whether or not the pre-crossing pedestrian Pp has started crossing (step S134). The deceleration controller 152 may determine whether or not the pre-crossing pedestrian Pp has started crossing even before a positive determination is obtained in step S132.

When the pre-crossing pedestrian Pp has not started the crossing, the deceleration controller 152 determines whether or not the subject vehicle M has passed through the crosswalk CR (step S136). When the deceleration controller 152 has determined that the subject vehicle M has passed through the crosswalk CR, the deceleration controller 152 accelerates the subject vehicle M up to the original speed to end the deceleration control (step S124 in FIG. 10). When the deceleration controller 152 has determined that the subject vehicle M has not passed through the crosswalk CR, the deceleration controller 152 returns to the process to step S134.

When the deceleration controller 152 has determined in step S134 that the pre-crossing pedestrian Pp has started crossing, the deceleration controller 152 switches the deceleration pattern to a deceleration pattern E to decelerate the subject vehicle M (step S138) and returns to the process of step S110 in FIG. 10. The deceleration pattern E is a deceleration pattern continuing from (3) indicated by a solid line in the deceleration pattern illustrated in FIG. 9.

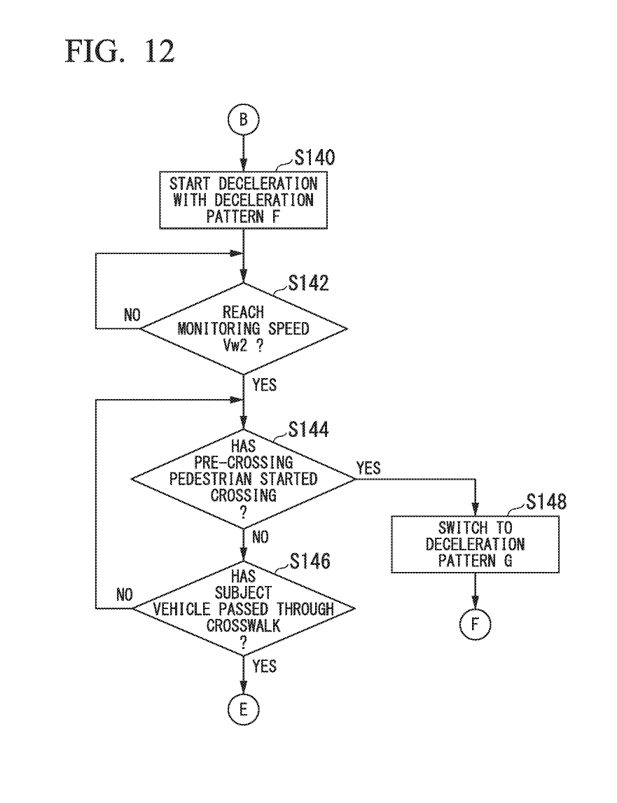

When a positive determination is obtained in step S120 of FIG. 10, the process proceeds to a process illustrated in FIG. 12. The deceleration controller 152 starts deceleration of the subject vehicle M with a deceleration pattern F (step S140). The deceleration pattern F is a deceleration pattern continuing from (2) indicated by a one-dot chain line in the deceleration pattern illustrated in FIG. 7. Then, the deceleration controller 152 determines whether or not the speed of the subject vehicle M has decreased to reach the monitoring speed Vw2 (step S142).

When the speed of the subject vehicle M decreases to reach the monitoring speed Vw2, the deceleration controller 152 determines whether or not the pedestrian P who has been the pre-crossing pedestrian Pp has been classified into the crossing pedestrian Pc, that is, whether or not the pre-crossing pedestrian Pp has started crossing (step S144). The deceleration controller 152 may determine whether or not the pre-crossing pedestrian Pp has started crossing even before a positive determination is obtained in step S142.

When the pre-crossing pedestrian Pp has not started the crossing, the deceleration controller 152 determines whether or not the subject vehicle M has passed through the crosswalk CR (step S146). When the deceleration controller 152 has determined that the subject vehicle M has passed through the crosswalk CR, the deceleration controller 152 accelerates the subject vehicle M up to the original speed to end the deceleration control (step S124 in FIG. 10). When the deceleration controller 152 has determined that the subject vehicle M has not passed through the crosswalk CR, the deceleration controller 152 returns to the process to step S144.

In step S144, when the deceleration controller 152 has determined that the pre-crossing pedestrian Pp has started crossing, the deceleration controller 152 switches the deceleration pattern to a deceleration pattern G to decelerate the subject vehicle M (step S148) and returns to the process of step S110 in FIG. 10. The deceleration pattern G is a deceleration pattern continuing from (1) indicated by a solid line in the deceleration pattern illustrated in FIG. 7.

According to the vehicle control device of the first embodiment described above, it is possible to perform appropriate deceleration on the basis of the situation of the crosswalk by including the recognizer (130) that recognizes the surrounding situation of the subject vehicle M, and the driving controller (150 and 160) that controls at least acceleration and deceleration of the subject vehicle M, the driving controller (150 and 160) decelerating the vehicle with different deceleration patterns on the basis of whether the crossing pedestrian Pc crossing the crosswalk CR has been recognized by the recognizer (130) at a point in time when the prior notice marking CM indicating the presence of the crosswalk CR in advance has been recognized by the recognizer (130).

### Second Embodiment

In a second embodiment, an example in which the vehicle control device has been applied to an automated stop assistance device will be described. For example, the automated stop assistance device is not mounted on an automatedally driven vehicle as in the first embodiment, but is mounted on a vehicle in which manual driving is mainly performed.

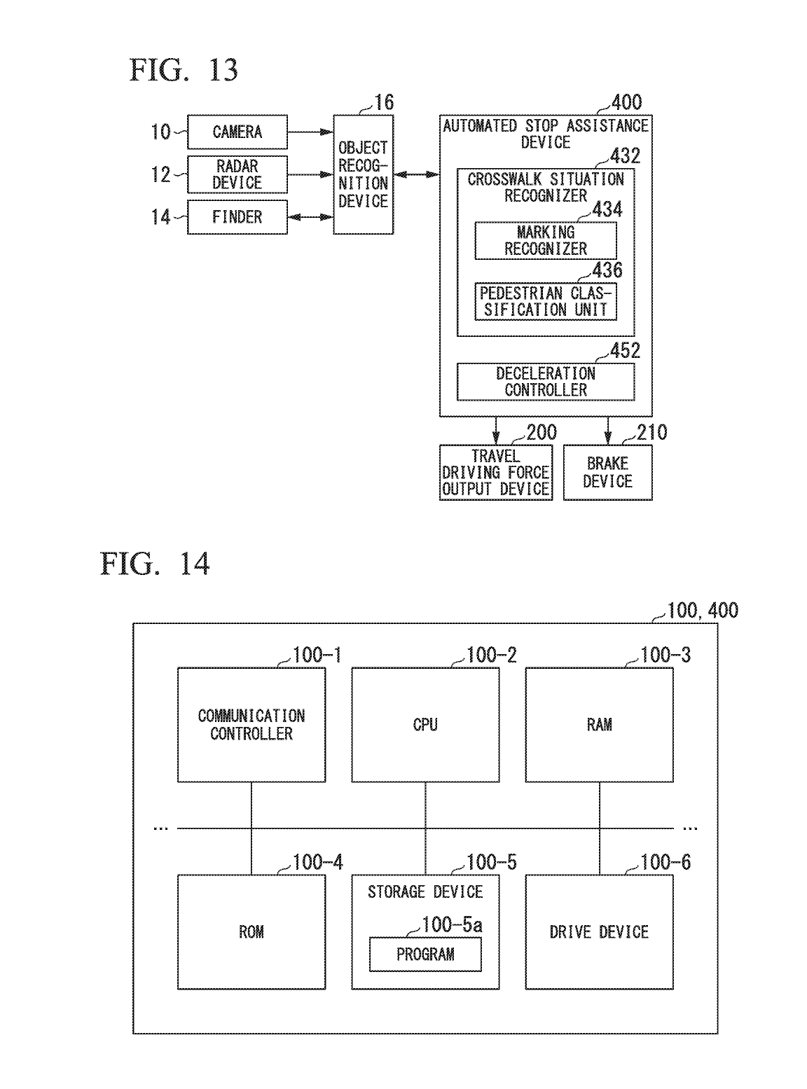

FIG. 13 is a configuration diagram of the automated stop assistance device 400 according to the second embodiment. The automated stop assistance device 400 includes, for example, a crosswalk situation recognizer 432 and a deceleration controller 452. The crosswalk situation recognizer 432 includes a marking recognizer 434 and a pedestrian classification unit 436. These components are realized, for example, by a hardware processor such as a CPU executing a program (software). Some or all of these components may be realized by hardware (including a circuitry) such as an LSI, an ASIC, an FPGA, or a GPU or may be realized by cooperation of software and hardware.

The crosswalk situation recognizer 432, the marking recognizer 434, the pedestrian classification unit 436, and the deceleration controller 452 have the same functions as those of the crosswalk situation recognizer 132, the marking recognizer 134, the pedestrian classification unit 136, and the deceleration controller 152 according to the first embodiment, respectively. Thus, the automated stop assistance device 400 of the second embodiment automatedally decelerates and/or stops the subject vehicle M according to the presence of the crossing pedestrian Pc or the pre-crossing pedestrian Pp in front of the crosswalk, as in the first embodiment.

The automated stop assistance device 400 may be configured integrally with another driving assistance device such as adaptive cruise control (ACC). In this case, the automated stop assistance device 400 may be configured to perform automated stop when the prior notice marking CM is discovered during execution of control according to the ACC. When the automated stop assistance device 400 is operating in front of the crosswalk, an occupant may be informed of the automated stop assistance device 400 being operating through voice and/or a display.

According to the second embodiment described above, it is possible to obtain the same effects as those of the first embodiment.

### Others

In each of the embodiments, a case in which a point at which the prior notice marking CM has been recognized is set as the deceleration start point has been described, but the present invention is not limited thereto. The deceleration start point may be a point at which the subject vehicle M is present after a predetermined time from the point at which the prior notice marking CM has been recognized, or a point at which the subject vehicle M has traveled a predetermined distance. From the beginning, for example, the position of the subject vehicle M may be compared with the second map information 62 without taking the prior notice marking CM into account, a point at a “predetermined distance up to the crosswalk” may be set as the deceleration start point, and the subject vehicle M may be decelerated with various deceleration patterns described in the embodiment.

### Hardware Configuration

FIG. 14 is a diagram illustrating an example of a hardware configuration of the automated driving controller 100 of the first embodiment or the automated stop assistance device 400 of the second embodiment (hereinafter, the automated driving controller 100 or the like). As illustrated in FIG. 14, the automated driving controller 100 or the like includes a communication controller 100-1, a CPU 100-2, a random access memory (RAM) 100-3 to be used as a working memory, a read only memory (ROM) 100-4 that stores a boot program or the like, a storage device 100-5 such as a flash memory or a hard disk drive (HDD), a drive device 100-6, and the like are mutually connected via an internal bus or a dedicated communication line. The communication controller 100-1 performs communication with a component other than the automated driving controller 100 or the like. A program 100-5a to be executed by the CPU 100-2 is stored in the storage device 100-5. This program is developed in the RAM 100-3 by a direct memory access (DMA) controller (not illustrated) or the like and executed by the CPU 100-2. Accordingly, one or both of the recognizer 130 and the action plan generation unit 150 or one or both of the crosswalk situation recognizer 432 and the deceleration controller 452 are realized.

The above-described embodiment can be expressed as follows.

A vehicle control device including
a storage device that stores a program, and
a hardware processor,
wherein the hardware processor is configured to execute the program to recognize a surrounding situation of a vehicle,
control at least acceleration and deceleration of the vehicle, and
decelerate the vehicle with different deceleration patterns on the basis of whether a pedestrian crossing a crosswalk has been recognized at a point in time when a marking indicating the presence of the crosswalk in advance has been recognized.

Although a mode for carrying out the present invention has been described above using the embodiment, the present invention is not limited to the embodiment at all, and various modifications and substitutions may be made without departing from the spirit of the present invention.

What is claimed is:

1. A vehicle control device comprising:
a recognizer that recognizes a surrounding situation of a vehicle; and
a driving controller that controls at least acceleration and deceleration of the vehicle, the driving controller decelerating the vehicle with different deceleration patterns on the basis of whether a pedestrian crossing a crosswalk has been recognized by the recognizer at a point in time when a marking indicating the presence of the crosswalk in advance has been recognized by the recognizer.

2. The vehicle control device according to claim 1,
wherein, when the pedestrian crossing the crosswalk has not been recognized by the recognizer at a point in time when the marking indicating the presence of the crosswalk drawn on a road has been recognized by the recognizer, the driving controller decelerates the vehicle with a first deceleration pattern set to include
a first period in which the vehicle is decelerated at a first degree of deceleration, and
a second period after the first period, the vehicle being decelerated at a second degree of deceleration lower than the first degree of deceleration or being caused to travel at a constant speed in the second period.

3. The vehicle control device according to claim 2, wherein, in a case in which the pedestrian crossing the crosswalk has been recognized by the recognizer in the second period when the driving controller decelerates the vehicle with the first deceleration pattern, the driving controller decelerates the vehicle at a third degree of deceleration higher than the second degree of deceleration.

4. The vehicle control device according to claim 1,
wherein the recognizer estimates whether or not a pedestrian recognized near the crosswalk intends to cross, and
the driving controller decelerates the vehicle due to the recognizer estimating that the pedestrian intends to cross, and then accelerates the vehicle after the driving controller causes the vehicle to pass through the crosswalk at a predetermined speed or less in a case in which the pedestrian estimated to intend to cross by the recognizer has not started crossing of the crosswalk.

5. The vehicle control device according to claim 2, wherein, in a case in which the pedestrian crossing the crosswalk has been recognized at a point in time when the marking indicating the presence of the crosswalk drawn on a road has been recognized by the recognizer, the driving controller decelerates the vehicle with a second deceleration pattern different from the first deceleration pattern.

6. The vehicle control device according to claim 5, wherein the second deceleration pattern is a deceleration pattern in which a fluctuation in deceleration is smaller than in the first deceleration pattern.

7. A vehicle control device comprising:
a recognizer that recognizes a surrounding situation of a vehicle; and
a driving controller that controls at least acceleration and deceleration of the vehicle, the driving controller decelerating the vehicle with different deceleration patterns on the basis of whether a pedestrian crossing the crosswalk has been recognized by the recognizer at a deceleration start point in front of the crosswalk.

8. A vehicle control method comprising:
recognizing, by a recognizer, a surrounding situation of a vehicle;
controlling, by a driving controller, at least acceleration and deceleration of the vehicle; and
decelerating, by the driving controller, the vehicle with different deceleration patterns on the basis of whether a pedestrian crossing the crosswalk has been recognized by the recognizer at a point in time when a marking indicating the presence of the crosswalk in advance has been recognized by the recognizer.

9. A computer-readable non-transitory storage medium storing a program for causing a computer to execute:
a process of recognizing a surrounding situation of a vehicle;
a process of controlling at least acceleration and deceleration of the vehicle; and
a process of decelerating the vehicle with different deceleration patterns on the basis of whether a pedestrian crossing the crosswalk has been recognized at a point in time when a marking indicating the presence of the crosswalk in advance has been recognized in the recognizing process.
